(19) United States
(12) Patent Application Publication
(10) Pub. No.: US 2026/0353491 A1
(43) Pub. Date: Nov. 5, 2026

(54) DISCOVERY ENHANCEMENTS FOR IMPROVED ROAMING

(71) Applicant: Cisco Technology, Inc., San Jose, CA (US)

(72) Inventors: Binita Gupta, San Diego, CA (US); Brian D. Hart, Sunnyvale, CA (US); Malcolm Muir Smith, Richardson, TX (US)

(73) Assignee: Cisco Technology, Inc., San Jose, CA (US)

(21) Appl. No.: 19/724,785

(22) Filed: Jun. 29, 2026

Related U.S. Application Data
(63) Continuation of application No. 19/532,570, filed on Feb. 6, 2026.
(60) Provisional application No. 63/754,867, filed on Feb. 6, 2025.
(60) Provisional application No. 63/756,688, filed on Feb. 10, 2025.
(60) Provisional application No. 63/767,849, filed on Mar. 6, 2025.
(60) Provisional application No. 63/878,697, filed on Sep. 9, 2025.

(51) Int. Cl. H04W 76/15; H04W 48/14

(52) U.S. Cl. CPC H04W 76/15; H04W 48/14

(57) ABSTRACT

Discovery enhancements for improved roaming may be provided. A client device may discover basic information for each of a plurality of Access Point (APs). Then the client device may select at least one of the plurality of APs as a seamless roaming candidate based on the basic information. Next, the client device may discover full information for the at least one of the plurality of APs.

### RELATED APPLICATIONS

This application is a continuation of U.S. patent application Ser. No. 19/532,570, filed Feb. 6, 2026, which under provisions of 35 U.S.C. § 119 (e), claims the benefit of U.S. Provisional Application No. 63/754,867, filed Feb. 6, 2025, U.S. Provisional Application No. 63/756,688, filed Feb. 10, 2025, U.S. Provisional Application No. 63/767,849, filed Mar. 6, 2025, and U.S. Provisional Application No. 63/878,697, filed Sep. 9, 2025, all of which are incorporated herein by reference.

### TECHNICAL FIELD

The present disclosure relates generally to providing discovery enhancements for improved roaming.

### BACKGROUND

In computer networking, a wireless Access Point (AP) is a networking hardware device that allows a Wi-Fi compatible client device to connect to a wired network and to other client devices. The AP usually connects to a router (directly or indirectly via a wired network) as a standalone device, but it can also be an integral component of the router itself. Several APs may also work in coordination, either through direct wired or wireless connections, or through a central system, commonly called a Wireless Local Area Network (WLAN) controller. An AP is differentiated from a hotspot, which is the physical location where Wi-Fi access to a WLAN is available.

Prior to wireless networks, setting up a computer network in a business, home, or school often required running many cables through walls and ceilings in order to deliver network access to all of the network-enabled devices in the building. With the creation of the wireless AP, network users are able to add devices that access the network with few or no cables. An AP connects to a wired network, then provides radio frequency links for other radio devices to reach that wired network. Most APs support the connection of multiple wireless devices. APs are built to support a standard for sending and receiving data using these radio frequencies.

### BRIEF DESCRIPTION OF THE FIGURES

The accompanying drawings, which are incorporated in and constitute a part of this disclosure, illustrate various embodiments of the present disclosure. In the drawings:

FIG. 1 is a block diagram of an operating environment for providing discovery enhancements for improved roaming;

FIG. 2 illustrates extending Reduced Neighbor Report (RNR) to add some extended Basic Service Set (BSS) parameters;

FIG. 3 illustrates Internet Protocol (IP) address continuity support indicated by using a reserved bit in the BSS parameters field;

FIG. 4 illustrates enhancing a Basic Service Set (BSS) Transition Management (BTM) Query such that a client device may request for an RNR element to be provided in the BTM Request frame, that is sent in response to the BTM Query;

FIG. 5 illustrates a BTM Request enhanced to provide an RNR element plus security related elements;

FIG. 6 illustrates an enhanced Neighbor Report (NR) element to allow providing a Robust Security Network Element (RSNE) or a Robust Security Network extension Element (RSNXE) as part of an Optional Subelements field;

FIG. 7 illustrates an enhanced Neighbot Report Request frame to allow inclusion of a Request element or an Extended Request element;

FIG. 8 illustrates an enhanced Neighbor Report Response frame to provide an RNR element;

FIG. 9 is a flow chart of a method for providing discovery enhancements for improved roaming;

FIG. 10 illustrates an extended Neighbor Report Request frame allowing inclusion of a Reason Code or an RNR element;

FIG. 11 illustrates that a Disassociation Imminent field may be set to 0 because an AP may not be Disassociating a client device;

FIG. 12 illustrates a bit in a Request Mode may be used to indicate ‘Neighbor Recommendation for Seamless Roaming’;

FIG. 13 illustrates one bit in a Request Mode may be used to signal ‘Extended Request Mode’;

FIG. 14 illustrates a Neighbor Probe Request/Response process;

FIG. 15A illustrates an extended Probe Request Multi-link element used for probing neighboring APs;

FIG. 15B illustrates a ‘AP MLD MAC Address’ field may be added in the Common Info field of the Probe Request ML element;

FIG. 16 illustrates an extended Basic Multi-Link element used to provide probe response content for neighboring APs; and

FIG. 17 is a block diagram of a computing device.

### DETAILED DESCRIPTION

### Overview

Discovery enhancements for improved roaming may be provided. A client device may discover basic information for each of a plurality of Access Point (APs). Then the client device may select at least one of the plurality of APs as a seamless roaming candidate based on the basic information. Next, the client device may discover full information for the at least one of the plurality of APs.

Both the foregoing overview and the following example embodiments are examples and explanatory only and should not be considered to restrict the disclosure's scope, as described and claimed. Furthermore, features and/or variations may be provided in addition to those described. For example, embodiments of the disclosure may be directed to various feature combinations and sub-combinations described in the example embodiments.

### Example Embodiments

The following detailed description refers to the accompanying drawings. Wherever possible, the same reference numbers are used in the drawings and the following description to refer to the same or similar elements. While embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

In the Institute of Electrical and Electronics Engineers (IEEE) 802.11 baseline, several processes may be defined for a client device to discover information about its neighboring Access Points (APs), and use that information for selecting a target AP for roaming. These processes may include: i) Neighbor Report Request/Response; ii) Reduced Neighbor Report (RNR) information in Beacon, Probe Response; ii) Basic Service Set (BSS) Transition Management (BTM) Query and BTM Request/Response; and iv) Probe Request/Response. Embodiments of the disclosure may enhance RNR for client devices to retrieve neighbor information in an efficient manner without adding too much overhead. Embodiments may also provide signaling for a client device to be able to retrieve RNR information using BTM Query and BTM Request, and Neighbor Report Request/Response. Embodiments of the disclosure may also define mechanism to fetch probe response content for one or more neighboring APs to retrieve detailed or full set of neighbor information for one or more neighboring APs or AP MLDs.

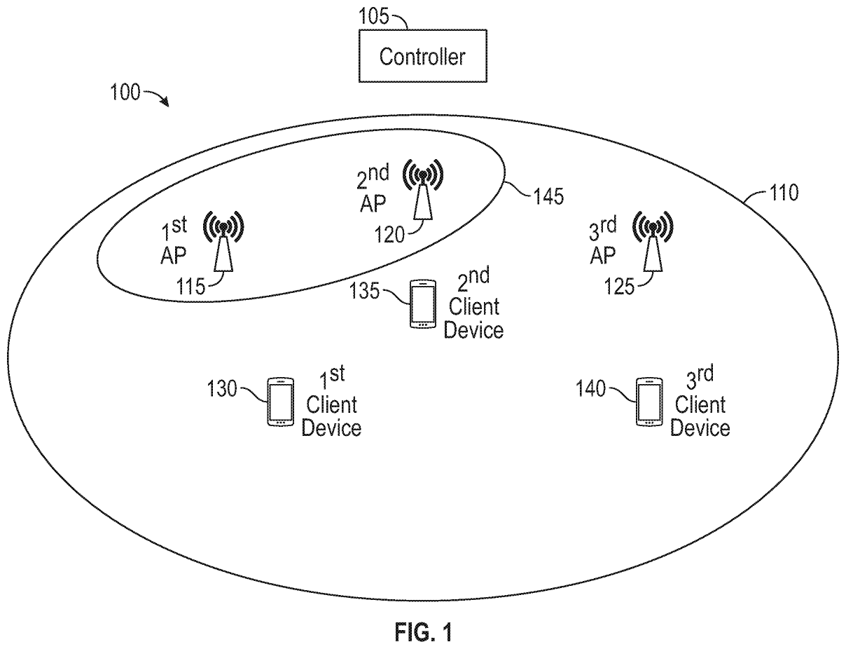

FIG. 1 shows an operating environment 100 for providing discovery enhancements for improved roaming. As shown in FIG. 1, operating environment 100 may comprise a controller 105 and a coverage environment 110. Coverage environment 110 may comprise, but is not limited to, a Wireless Local Area Network (WLAN) comprising a plurality of Access Points (APs) that may provide wireless network access (e.g., access to the WLAN for client devices). The plurality of APs may comprise a first AP 115, a second AP 120, a third AP 125. As described below, the plurality of APs may comprise any number of APs and is not limited to three. The plurality of APs may provide wireless network access to a plurality of client devices (i.e., Station (STAs)) as they move within coverage environment 110. The plurality of client devices may comprise, but are not limited to, a first client device 130, a second client device 135, and a third client device 140. The APs in the environment may be grouped into one or more Seamless Mobility Domains (SMDs) as shown by SMD 145 which provide seamless roaming to clients across AP MLDs within the SMD. A client device may associate with SMD 145 and then roam across AP MLDs within SMD 145 without reassociation.

The plurality of client devices may comprise non-AP Multi-Link Devices (MLDs). Ones of the plurality of client devices may comprise, but are not limited to, a smart phone, a personal computer, a tablet device, a mobile device, a telephone, a remote control device, a set-top box, a digital video recorder, an Internet-of-Things (IoT) device, a network computer, a router, an Automated Transfer Vehicle (ATV), a drone, a vehicle, an autonomous vehicle, an Unmanned Aerial Vehicle (UAV), Virtual Reality (VR)/Augmented Reality (AR) devices, or other similar microcomputer-based device. Each of the plurality of APs may be compatible with specification standards such as, but not limited to, the Institute of Electrical and Electronics Engineers (IEEE) 802.11 specification standard.

The plurality of APs and the plurality of client devices may use Multi-Link Operation (MLO) where they simultaneously transmit and receive across different bands (or links) and channels by establishing two or more links to two or more AP radios. Accordingly, the plurality of APs and the plurality of client devices may comprise Multi-Link Devices (MLDs). These bands may comprise, but are not limited to the 2.4 GHz band, the 5 GHz band, the 6 GHz band, and the 60 GHz band. The two or more links on any given one of the plurality of client devices may be made with any one AP or with any combination of the APs.

Controller 105 may comprise a Wireless Local Area Network controller (WLC) and may provision and control coverage environment 110 (e.g., a WLAN). Controller 105 may allow first client device 130, second client device 135, and third client device 140 to join coverage environment 110. In some embodiments of the disclosure, controller 105 may be implemented by a Digital Network Architecture Center (DNAC) controller (i.e., a Software-Defined Network (SDN) controller) that may configure information for coverage environment 110 in order to provide discovery enhancements for improved roaming.

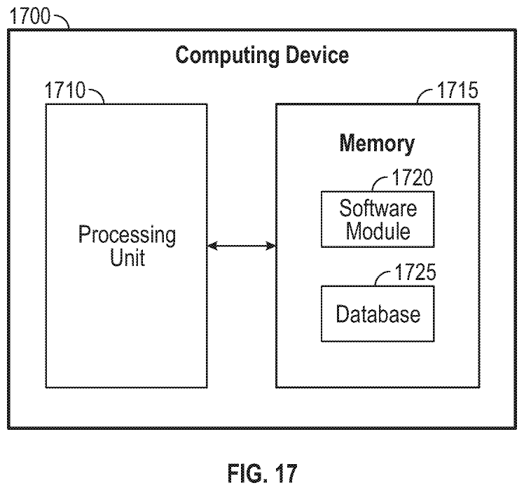

The elements described above of operating environment 100 (e.g., controller 105, first AP 115, second AP 120, third AP 125, first client device 130, second client device 135, or third client device 140) may be practiced in hardware and/or in software (including firmware, resident software, micro-code, etc.) or in any other circuits or systems. The elements of operating environment 100 may be practiced in electrical circuits comprising discrete electronic elements, packaged or integrated electronic chips containing logic gates, a circuit utilizing a microprocessor, or on a single chip containing electronic elements or microprocessors. Furthermore, the elements of operating environment 100 may also be practiced using other technologies capable of performing logical operations such as, for example, AND, OR, and NOT, including but not limited to, mechanical, optical, fluidic, and quantum technologies. As described in greater detail below with respect to FIG. 17, the elements of operating environment 100 may be practiced in a computing device 1700.

Embodiments of the disclosure may use existing RNR format and extend it to add some additional fields that may be useful for neighbor AP selection for roaming (instead of defining a new RNR format). Embodiments may provide signaling enhancement to fetch the RNR using existing neighbor discovery mechanisms (e.g., BTM Query/BTM Request and Neighbor Report Request/Response). Also, inheritance may be applied among Neighbor Reports included in a management frame that may include multiple Neighbor Report (NR) elements, for optimizing size of the frame. The inheritance gets applied across Neighbor Report (NR) elements where subelements that are same for all reported neighbors are included only once in the neighbor reports, for one of the neighbor and other neighboring APs inherit that element. This inheritance scheme can be applied to Neighbor Report Response frame or BTM Request frame or another frame carrying multiple Neighbor Report (NR) elements.

### Extend RNR to Add Extended Set of BSS Parameters for Neighboring APs

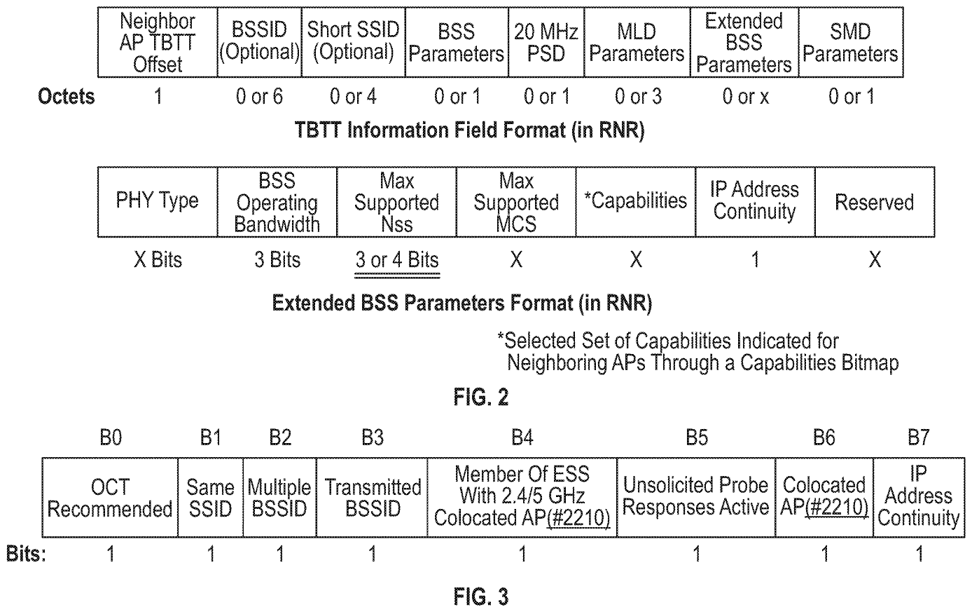

Embodiments of the disclosure may extend RNR Reduced Neighbor Report (RNR) elements to add some extended BSS parameters for the reported (neighboring) AP as shown in FIG. 2. The RNR element may provide information on neighboring APs that may be in the same Single Mobility Domain (SMD) or may belong to another SMD.

The extended BSS parameters may include one or more of following:
i) PHY Type (as defined in the NR element, e.g., with fewer number of bits used 4/6/8 bits);
ii) Same SMD indication, indicating whether reported AP is part of same SMD as the reporting AP;
iii) BSS Operating Band Width (BW)—channel width where reported AP's BSS is operating currently;
iv) Max Supported Number of Spatial Streams (NSS)—the maximum NSSs that may be supported across any channel widths. In another embodiment, Max Supported NSS may be indicated per BW—indicate maximum NSS supported for each of the BWs-20, 40, 80, 160 and 320 MHz and 640 MHz in future;
v) Max Supported Modulation Coding Scheme (MCS)—the maximum or the highest MCS supported across any channel widths. In another embodiment, Max Supported MCS may be indicated per BW—indicate maximum or the highest MCS supported for each of the BWs—20, 40, 80, 160 and 320 MHz and 640 MHz in future;
vi) Capabilities—a selected set of capabilities for the BSS (similar to NR element). Embodiments may provide a selected set of capabilities for the neighbor BSS in RNR element;
vii) Internet Protocol (IP) Address Continuity—indicates whether neighboring BSS provides IP address continuity with respect to the reporting AP;
viii) Association disallowed, indicating whether the association is disallowed at the neighboring AP currently (not shown in FIG. 2); and
ix) Max Supported PHY Data Rate—indicates the maximum PHY data rate that the AP supports.

In another embodiment, the IP Address continuity support may be indicated by using a reserved bit in the BSS parameters field, as shown in FIG. 3. The Target Beacon Transmission Time (TBTT) Information Field Type 0 may be used for this extension. This may not not require defining a new TBTT Information Field Type value. The RNR element may also include the SMD parameters for Seamless Mobility Domain. The set of neighboring APs for which information may be provided in the RNR element may be selected by the network. For example, this may include a subset of neighboring APs in the same SMD/Extended Service Set (ESS) as the reporting AP transmitting the RNR element.

### Enhance BTM Query and BTM Request to Request and Provide the RNR Element

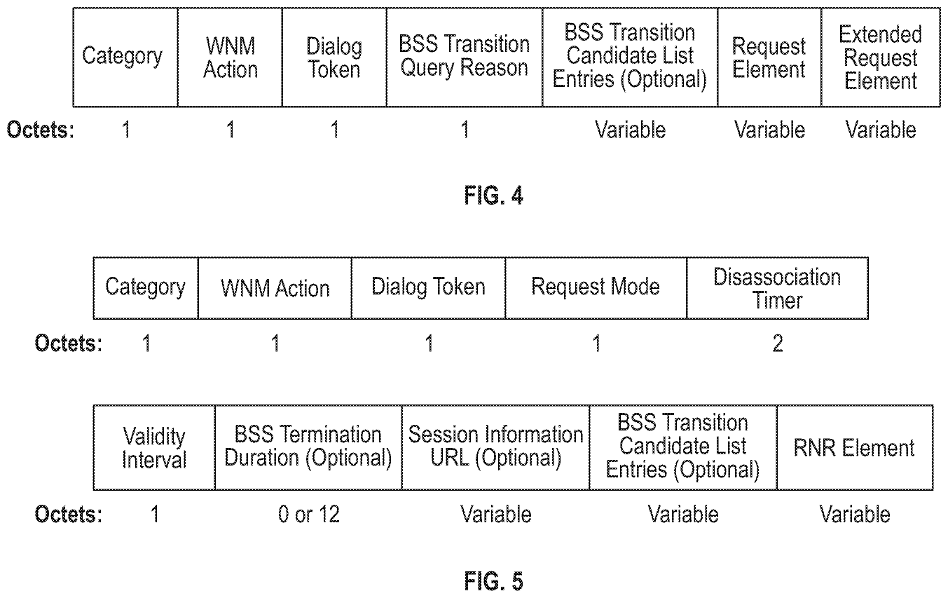

Conventional BTM Query frames may not specifically request RNR to be provided by the AP in response. The response to a BTM Query may be a BTM Request that provides one or more Neighbor Report elements for neighboring APs. The conventional BTM Request frame does not provide the RNR element. The RNR element that is carried in the Beacon frames may not include reduce neighbor report information for neighboring APs/AP MLDs which are not collocated with the reporting AP transmitting the Beacon frame and may only include information for other collocated APs. This is to minimize RNR element size in Beacon. Thus, in conventional systems, RNR in Beacon may not provide information for non-collocated neighboring APs of the reporting AP transmitting the beacon frame. Embodiments of the disclosure may enhance the BTM Query such that a client device may request for an RNR element to be provided in the BTM Request frame, that is sent in response to the BTM Query. In this case, the RNR element included in the BTM Request would provide information for non-collocated neighboring APs as well of the transmitting AP (plus optionally collocated APs too). FIG. 4 illustrates the aforementioned enhancement. In one embodiment, a value for the BSS Transition Query Reason field in the BTM Query may be defined that may be used by the client device to indicate to the AP that it is requesting the RNR element that provides information for non-collocated neighboring APs as well of the transmitting AP (plus optionally collocated APs too). For example, a new “Requesting RNR for neighbor discovery” may be used. In another embodiment, a Request element and/or Extended Request element may be added in the BTM query that explicitly lists RNR, indicating to the AP that the client device is requesting RNR. One example format is shown in FIG. 4 where Request element and/or Extended Request element is added to the BTM Query frame. Other elements may also be requested in the BTM Query with these elements.

In one embodiment, the client device may include a Request element and/or Extended Request element and indicates other elements it is requesting for each of the reported neighboring APs. For example, the Request element and/or Extended Request element may signal that the client device is requesting a BSS Load element, a Robust Security Network Element (RSNE), a Robust Security Network eXtension Element (RSNXE), UHR Operation elements, UHR Capabilities elements, SMD Information element, UHR Security Information element, UHR Parameters Update element, TID-to-Link Mapping element etc. The current AP that receives the BTM Query may provide the requested set of information (elements) in the BTM Request sent in response to the BTM Query, as part of the Optional Subelements field in the NR element. Embodiments of the disclosure may enhance the BTM Request to also provide an RNR element as described above, where the RNR element included in the BTM Request would provide information for non-collocated neighboring APs of the transmitting AP as well (plus optionally collocated APs too). An example format is shown in FIG. 5.

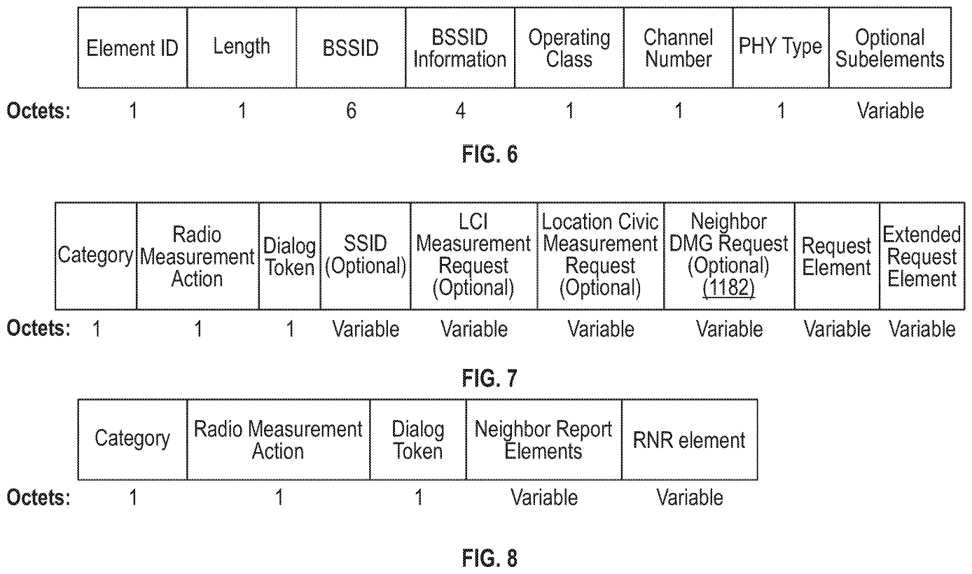

In one embodiment, the BTM Request may only include the RNR element (provide information for non-collocated neighboring APs of the transmitting AP as well) and does not include the Neighbor Report elements in the BSS Transition Candidate List Entries. This may optimize the size of the BTM Request sent. In another embodiment, the BTM Request may include NR elements in BSS Transition Candidate List Entries, in addition to the RNR element. In yet another embodiment, the BTM request includes only NR elements (that provides additional elements) and may not include RNR element. The NR elements may provide the list of other elements requested in the Request element and/or Extended Request element included in the BTM Query or provide additional elements based on some rules defined or AP side policy, as part of Optional Subelements field. In conventional systems, the NR element may not allow providing an RSNE or RSNXE element or some of the other elements listed above as part of Optional Subelements field in the NR element. Embodiments of the disclosure may enhance the NR element to allow providing one or more of RSNE, RSNXE, UHR Operation elements, UHR Capabilities elements, SMD Information element, UHR Security Information element, Basic Multi-Link element, UHR Parameters Update element, TID-to-Link Mapping element etc. as part of the Optional Subelements field in the NR element in the format shown in FIG. 6. In one embodiment, if the neighboring AP reported in the NR element is an affiliated AP of a UHR AP MLD (which is either part of an SMD or not part of an SMD), then UHR Security Information element is provided in the NR element (in Optional Subelements field) instead of RSNE and/or RSNXE (or UHR Security Information element+RSNXE are included), to provide UHR defined security parameters (which can be SMD level security parameters if AP MLD is part of an SMD). If the neighboring AP MLD is part of an SMD, then the SMD Information element and UHR Security Information element are only included in the NR element if the neighboring AP MLD is part of a different SMD. This is because these elements carry same information for all APs/AP MLDs of an SMD. Following provides a brief description of some of these elements:
SMD Information element: carries SMD identifier and SMD level capabilities and/or parameters.
UHR Security Information element: carries security capabilities and parameters defined for UHR. If the AP MLD is part of the SMD, then this provides SMD level security parameters.
UHR Parameters Update element: provides information about any ongoing critical updates at the AP MLD.
TID-to-Link Mapping element: provides information about temporary link disablement indicated using advertised TID-to-link mapping feature as defined in IEEE 802.11be.

### Enhanced Neighbor Report Request/Response to Request/Provide RNR Element

Similar to the Enhance BTM Query and BTM Request to Request and Provide the RNR Element as described above, embodiments of the disclosure may enhance Neighbor Report Request frame to request specifically for the RNR element, by inclusion of a Request element or an Extended Request element as shown in FIG. 7. The RNR may be indicated in the Request element. The Request element and the Extended Request element may indicate any other element that the client device is requesting. In one embodiment, another field can be used in the Neighbor Report Request frame to indicate request for RNR element in the response.

Furthermore, embodiments of the disclosure may enhance the Neighbor Report Response frame to provide RNR element in response to a Neighbor Report Request frame that requested for the RNR element. The RNR element included in the Neighbor Report Response would provide information for non-collocated neighboring APs of the transmitting AP as well (plus optionally collocated APs too). One possible format is illustrated by FIG. 8. Along with the RNR element, the NR elements may also be included to provide a specific set of elements that were requested by the client device in the Neighbor Report Request frame.

### Apply Inheritance Across Neighbor Report Elements

When Neighbor Reports (NR) elements are provided for multiple neighboring APs in a management frame, some of the information provided across those neighboring APs may be the same. To reduce the overall size of the management frame containing multiple NR elements, embodiments of the disclosure may apply inheritance across multiple Neighbor Report elements in a frame. Embodiments of the disclosure may apply inheritance across multiple Neighbor Report elements in the BTM Request (even BTM Query), Neighbor Request Response, and any other management frames that may include multiple Neighbor Report elements.

The following process may be used to apply inheritance across NR elements. First, the Optional Subelements field in the first NR element in the frame may include the optional subelements for the corresponding AP. Next, the subsequent NR elements may inherit the optional subelements from the first NR element, unless a Non-inheritance element is included in the Optional Subelements field of that NR element, listing the set of elements that are not inherited. The Optional Subelements field of each NR element may include the subelements that are specific to that NR element. This may include: i) any element not included in the first NR element but that are applicable and need to be included for the current NR element; and ii) any elements that are included in the first NR element but that have different values for the current NR element. Then, for 2nd, 3^{rd}, and subsequent NR elements, the client device may apply the inherited optional subelements (as inherited from the 1^{st} NR element) as well as the subelements that may be specific to that NR element.

For example, if an RSNE element is provided in the first NR element, and other neighboring APs have the same RSNE parameter values, then RSNE may not be included in the NR elements for other neighboring APs. Instead, RSNE may be inherited from the first NR element to all the other neighboring APs. If one neighboring AP offers slightly different RSNE parameters (e.g., different set of AKMs), then for the NR element of that AP, RSNE gets included.

The management frame providing the response may also provide an explicit signaling that may indicate whether inheritance is applied across NR elements in the response frame (e.g. BTM Request frame, Neighbor Report Response frame etc.). For example, a Reserved bit in the BSSID Information field in the first NR element may indicate whether inheritance is applied.

### Capability Indication

Capability support for providing RNR in BTM Request and Neighbor Report Response may be indicated by the AP using a capability bit (e.g., a capability bit in the Extended Capabilities element or Ultra-High Reliability (UHR) Capabilities element or another element). The client device may send a request asking for RNR in these frames only if the AP has indicated support for this capability.

### Neighbor Discovery for Seamless Roaming

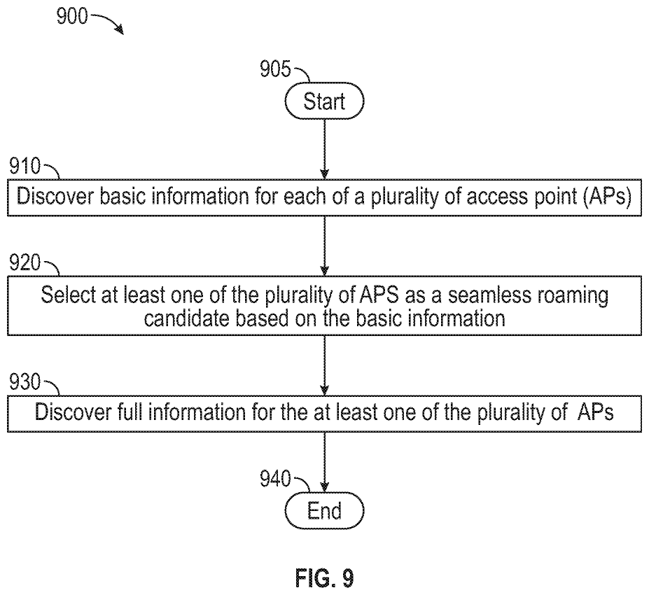

Neighbor discovery for seamless roaming through a serving AP may include: i) the client device discovering some basic information for several neighboring AP MLDs; and ii) the client device then down selecting to one or a few neighboring AP MLDs as seamless roaming candidates and discovers a full or detailed set of information for those neighboring AP MLDs. RNR may provide some basic set of information for neighboring APs. RNR may provide information for both collocated and non-collocated APs as described above. Extend RNR to add SMD parameters may provide extension with some extended BSS parameters to assist in the AP down selection. A first stage may comprise sending an extended BTM query to request for RNR and/or selected elements (e.g., BSS Load, RSNE, RSNXE, UHR Operation, etc.) in Neighbor Report elements in the BTM Request. A second stage may comprise a client device performing neighbor Probe Request/Response to retrieve detailed or full set of information for selected neighboring AP MLDs/APs through a current AP. This process is described in greater detail below with respect to FIG. 9.

FIG. 9 is a flow chart setting forth the general stages involved in a method 900 consistent with embodiments of the disclosure for providing discovery enhancements for improved roaming. Method 900 may be implemented using first client device 130 embodied by computing device 1700 as described in more detail below with respect to FIG. 17. Ways to implement the stages of method 900 will be described in greater detail below.

Method 900 may begin at starting block 905 and proceed to stage 910 where first client device 130 may discover basic information for each of the plurality of APs. For example, an extended BTM query may be sent to request for RNR and/or selected elements (e.g., BSS Load, RSNE, RSNXE etc.) in Neighbor Report elements in the BTM Request. In one embodiment, the extended BTM query indicates specific Query Reason to query information for the neighboring APs/AP MLDs in the SMD e.g. a Query Reason of either ‘Neighbor Discovery within SMD’ or ‘Request neighbor recommendation for seamless/SMD roaming’. Extending RNR for seamless roaming may comprise adding SMD parameters and adding some extended BSS parameters (e.g., in 2/3/4 octets). This is described in detail above with respect to FIG. 2.

### Extend BTM Query and BTM Request—BTM Query

As described above with respect to FIG. 4, a Request element and an Extended Request element may be added to allow requesting for RNR and other specific elements to be sent in a BTM Request. In one embodiment, for BTM Query new BSS Transition Query Reason values may be defined to signal “Neighbor Discovery” or “Neighbor Discovery within SMD”. Alternatively, a Request element and an Extended Request element may be carried in an NR element in an Optional Subelements field. A BSSID field in an NR element may indicate a wildcard (e.g., set to all 0's or all 1's) to signal a request for all relevant neighboring APs.

Embodiments of the disclosure may include an enhanced BTM Query to request for a different set of information using different BSS Transition Query Reason values. For example, one or more new BSS Transition Query Reason values may be defined to indicate a query for ‘Neighbor Discovery’ or ‘Neighbor Discovery within SMD’ or ‘Request neighbor recommendation for seamless/SMD roaming’ or ‘Request to prepare neighboring AP for direct target roaming in SMD’.

### Extend BTM Query and BTM Request—BTM Request

As described above with respect to FIG. 5, a BTM Request may be enhanced to provide an RNR element. In some embodiments, BTM Request may be enhanced to provide additional elements in the Optional Subelements field of the NR element e.g. RSNE, RSNXE, SMD Information element, UHR Security Information element, UHR Operation element, UHR Capabilities element, Basic Multi-Link element, UHR Parameters Update element, TID-to-Link Mapping element etc. In some embodiments, some of these elements may be included in the Optional Subelements field of the NR element always if reported AP/AP MLD is a UHR AP MLD (and/or part of the SMD) or included based on AP side policy. This could be independent of what specific query reason is specified in the BTM Query (e.g., all or a subset of BSS Load element, RSNE, RSNXE, UHR Operation element, UHR Capabilities element, SMD Information element (if different SMD), UHR Security Information element, Basic Multi-Link element, UHR Parameters Update element, TID-to-Link Mapping element may always be included). In one embodiment, if the reported AP is a UHR APs/AP MLDs then the UHR Security Information element is included instead of RSNE or RSNXE (or UHR Security Information element plus RSNXE are included). A serving AP may: i) return a set of Neighboring APs per Query Reason (e.g., return information only for neighboring APs in the same SMD vs all neighboring APs); ii) return additional APs if needed; and iii) apply inheritance across NR elements returned in the BTM Request (as described above) for reducing size (e.g., if all reported APs have same RSNE and/or RSNXE, then RSNE and RSNXE may be included only once).

Embodiments of the disclosure may include an enhanced BTM Request to provide information based on the BSS Transition Query Reason in the associated BTM Query. For example, a rule may be defined to always provide certain specific elements (e.g., BSS Load, SMD Information element (if different SMD), RSNE element and/or RSNXE element, UHR Security Information element, UHR Operation element, UHR Capabilities element, Basic Multi-Link element, UHR Parameters Update element, TID-to-Link Mapping element etc.) when the BTM Query includes a Query Reason of ‘Neighbor Discovery within SMD’ or ‘Request neighbor recommendation for seamless/SMD roaming’. If the reported AP/AP MLD is part of the SMD, then the SMD Information element and the UHR Security Information element may only be included if the reported AP/AP MLD is part of different SMD.

### Extend BTM Query and BTM Request—Unsolicited BTM Request by Serving AP

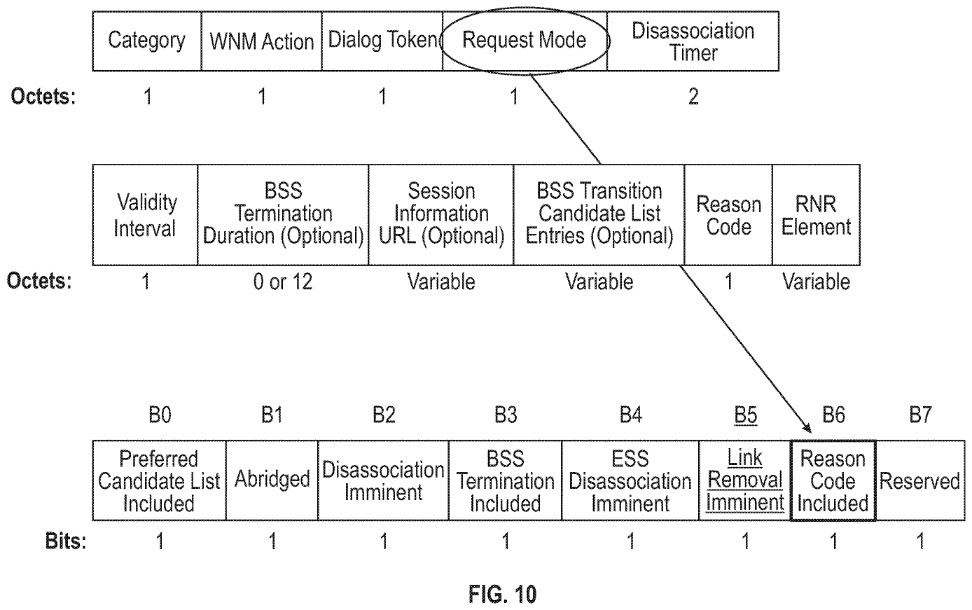

Conventional systems may send unsolicited BTM Requests to recommend BSS transition to specific AP MLDs. For seamless roaming, embodiments of the disclosure may enable a serving AP to provide neighbor APs information without specifically asking for a client device to perform BSS transition (e.g., to provide a set of APs to consider for seamless roaming). Accordingly, embodiments of the disclosure may add a Reason Code/Status Code to a BTM Request to signal specific reason for sending unsolicited BTM Request e.g. signal a “Neighbor Discovery Assistance” as a reason for providing BTM Request as shown in FIG. 10. The Request Mode field may indicate that the Reason Code in included and then a Reason Code is included as part of the BTM Request as shown in FIG. 10. This indicates to the client that the BTM Request is providing (updated) information for neighboring APs to assist client in its neighbor discovery, e.g. for SMD roaming. Without including a Reason Code, the client may not know exactly why the unsolicited BTM Request was sent and may just drop the frame and not use it. Hence, providing a specific reason enables client to better process and use the information provided in the BTM Request. The Reason Code field can indicate other possible reasons as described below.

The presence of a Reason Code may be signaled in the Request Mode field. A conventional BTM Query may include a “Query Reason”. Embodiments of the disclosure may enhance a BTM Request to provide a reason for indicating the purpose of the BTM Request. A Reason Code may also provide a status when the BTM Request is sent in response to a BTM Query (e.g., may indicate that partial or complete neighbor information is provided or a failure reason if cannot provide neighbor information). Alternatively, the Reason Code may be provided as part of a new element added to the BTM Request. New values may be added to “Transition and Transition Query Reasons” field for this or a completely new ‘Reason Code’ field may be defined.

There may be at least following possible reasons (e.g., indicated in reason code) why a serving AP may send an unsolicited BTM Request: i) Neighbor Discovery Information push (e.g., when the AP wants to push latest Neighbor information to the client device when Neighbor Information changes such as BSS Load, operation parameters etc.); ii) Neighbor Recommendation for Seamless/SMD Roaming (e.g. when the AP wants to recommend a set of neighboring APs for the client device to consider if/when performing seamless roaming); iii) Pre-roaming Preparation Completion for Direct Target roaming (e.g., when the AP wants to indicate that a set of neighbor AP MLDs or all neighboring AP MLDs are prepared with static context for the client device to directly roam through the target AP MLD (in this case, if there are large number of AP MLDs to report then the Optional Subelements may not include elements or include very few elements to keep the size small); and iv) BSS Transition for Seamless Roaming (e.g., when the AP wants to request the client device to perform seamless roaming to a specific target AP MLD(s) (with Disassociation Imminent=0)).

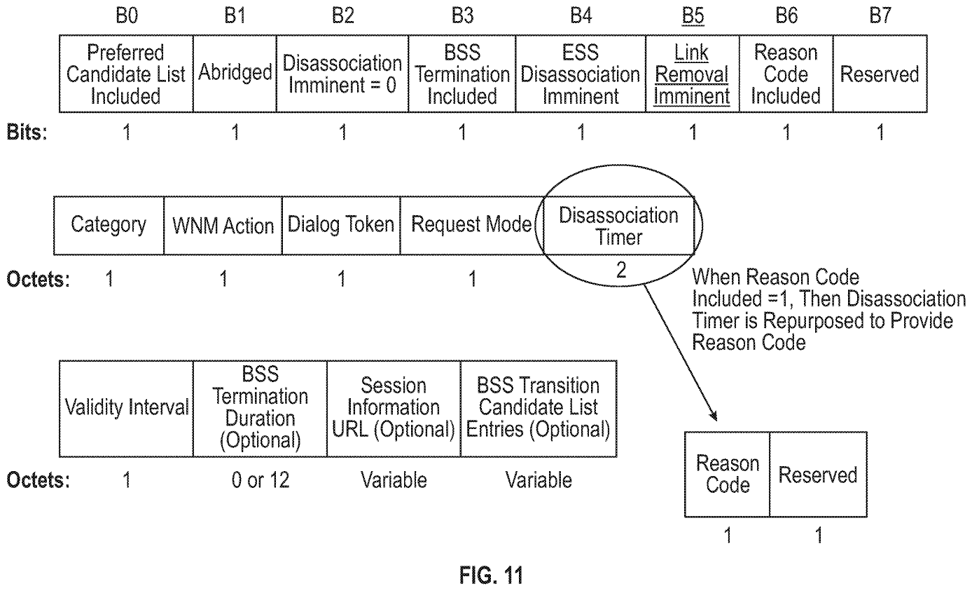

As illustrated in FIG. 11, in all these cases when the AP is sending an unsolicited BTM Request, a Disassociation Imminent field may be set to 0 because the AP may not be Disassociating the client device. If the Disassociation Imminent field is set to 0, then the Disassociation Timer field may be reserved and not used in the current IEEE 802.11 baseline standard. Embodiments of the disclosure may repurpose the Disassociation Timer field to indicate a Reason Code in the BTM Request when Disassociation Imminent field is set to 0. Inclusion of the Reason Code may be indicated by a Reason Code Included field in the Request Mode field in the NR element or alternatively Reason Code may be included when Disassociation Imminent field is set to 0. The Reason Code may be one octet or smaller in size, and different values may indicate the reasons mentioned above and plus any other reasons for the BTM Request may be indicated. Such a Reason Code may also be provided in the BTM Request sent in response to the BTM Query (in which case it can also be used to provide the status for the BTM Query or one of the reasons indicated above).

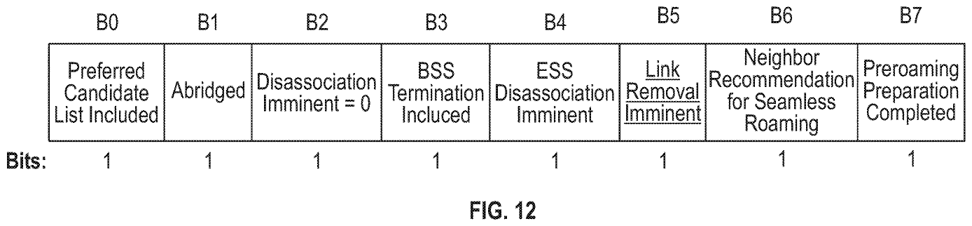

To indicate possible reasons as described above in the BTM Request, another approach may be to use Reserved bits in the Request Mode field in the NR element, and/or also repurpose the ‘Disassociation Timer’ for this. As illustrated in FIG. 12, a bit in the Request Mode may be used to indicate ‘Neighbor Recommendation for Seamless Roaming’. Another bit in the Request Mode may be used to indicate ‘Pre-roaming Preparation completed’ or another desired Reason or keep it reserved.

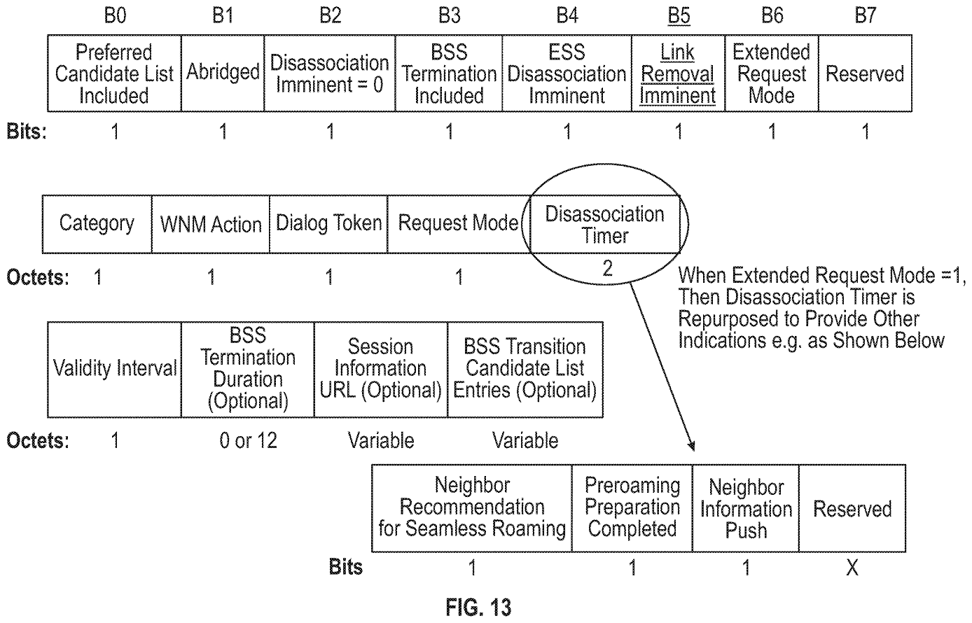

In another embodiment, one bit in the Request Mode may be used to signal ‘Extended Request Mode’ or similar indicating that bits in the Disassociation Timer field are used for indicating specific aspects for the BTM request as illustrated in FIG. 13. Then the Disassociation Timer may be defined to use bits to indicate specific reasons for the BTM Request. For example, 3 or 4 bits may be used, each one indicating the specific reason and set to 1 if the BTM Request is sent for that reason. In all cases, the Disassociation Imminent may be set to 0, hence per the IEEE 802.11 baseline, the Disassociation Timer field may be reserved.

In one embodiment, the Neighbor Report Response may be enhanced to provide a Reason Code for why the information is provided in the response frame, similar to as described for the BTM Request above. The reason code may signal one of the reasons described above of other reasons. In one embodiment, the Neighbor Report Response frame may be sent unsolicited by the AP providing neighboring APs information along with a reason code.

From stage 910, where first client device 130 discovers the basic information for each of the plurality of APs, method 900 may advance to stage 920 where first client device 130 may select at least one of the plurality of APs as a seamless roaming candidate. For example, first client device 130 may select the at least one of the plurality of APs as a seamless roaming candidate based on the basic set of information received for neighboring APs in BTM Request frame or Neighbor Report Response frame.

Once first client device 130 selects the at least one of the plurality of APs as the seamless roaming candidate based on the basic information in stage 920, method 900 may continue to stage 930 where first client device 130 may discover full information for the at least one of the plurality of APs. For example, first client device 130 may perform a neighbor Probe Request/Response exchange to retrieve detailed or full set of information (e.g., detailed AP information that is obtained in a probe response) for the selected neighboring AP MLDs (i.e., the at least one of the plurality of APs selected as the seamless roaming candidate). This may be performed through the AP (i.e., serving AP) that the first client device 130 is current attached to. In one embodiment, client device may perform neighbor Probe Request/Response exchange independent of first explicitly performing discovery of basic set of information for neighboring APs. In this case, the client device may have received identifier for neighboring AP/AP MLD from past reception of beacon frames or past exchange of direct probe request/response with the neighboring AP (e.g. active scanning). In this case, the client device may skip step 910 and directly select at least one neighboring AP/AP MLD to fetch detailed or full set of information as provided in a probe response.

Neighbour Probe Reg/Resp through Serving AP.

A client device may need a detailed/complete set of information (e.g., as obtained in Probe Response) to perform seamless roaming to a candidate target AP MLD/AP. Accordingly, embodiments of the disclosure may define Neighbor Probe Request/Response frames to probe for detailed/complete information for one or more neighboring AP MLDs/APs through a serving AP MLD to minimize disruptions due to off-channel scans for the client.

To achieve this, a Probe Request Multi-Link (ML) element may be extended to signal probing for a neighboring AP (i.e., a neighbor Probe Request ML element). A Probe Request frame that includes neighbor Probe Req ML element(s) may comprise a Neighbor Probe Request. A Neighbor Probe Request may include Request element and/or Extended Request element(s) to indicate specific elements being requested for neighboring APs/AP MLDs. A Neighbor Probe Request may include one or more neighbor Probe Req ML elements, one for each neighbor AP MLD or AP for which detailed probe response content is being requested by the client. Neighbor Probe Request may also specify a probe request for non-MLD neighboring APs (per BSSID). A Neighbor Probe Response may comprise a Probe Response frame that may include one or more Basic ML element that may carry complete or partial profile(s) for neighboring AP MLDs/APs. Neighbor Probe Request/Response frames may be exchanged as Protected Management Frames (PMFs) protected with serving AP MLD to provide desired privacy.

In some embodiments, given the Probe Request and Probe Response frames are used by all legacy STAs, then using these frames for requesting probe response content for neighboring APs (i.e., probing neighboring APs) may lead to some compatibility issues with legacy clients, since those legacy clients may not understand a Probe Response frame sent by an AP is providing probe response content for a neighboring AP/AP MLD of the reporting AP (i.e. the AP transmitting the frame). Hence to avoid such legacy compatibility issues, the Neighbor Probe Request and Neighbor Probe Response frames may be defined as new Action frames, instead of reusing the Probe Request and Probe Response frames for this purpose.

### Neighbour Probe Request/Response Through Current AP.

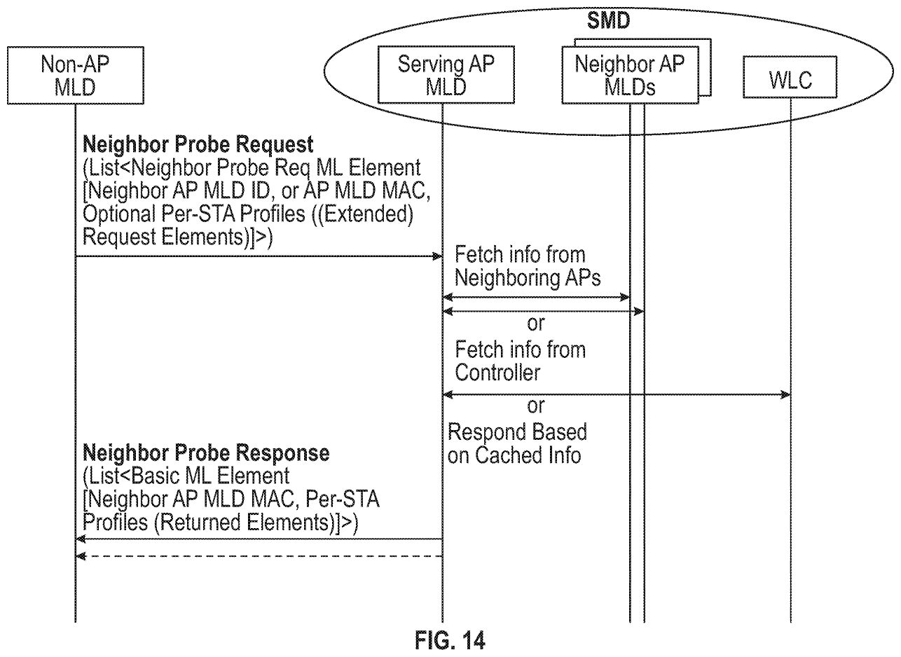

FIG. 14 provides a flow for Neighbor Probe Request and Response exchange between the client device and the serving AP MLD. The client (or non-AP MLD) sends a Neighbor Probe Request frame to its serving AP MLD. This request includes one or more Neighbor Probe Request ML element, which as described above is an extended Probe Request ML element, extended for probing neighboring APs/AP MLDs. The Neighbor Probe Request ML element includes a field to identify the neighboring AP MLD for which probe reponse information is being requested. This may be a neighbor AP MLD ID or a neighbor AP MLD MAC address. Then optionally, the Neighbor Probe Request frame may include one or more Per-STA Profile subelements for each affiliated AP of the neighbor AP MLD for which information is requested, and optionally may include a Request element or Extended Request element if requesting partial profile for the affiliated APs.

As illustrated by FIG. 14, after receiving a Neighbor Probe Request frame, the serving AP MLD may use any of the following approaches to generate a response: i) fetch neighbor information directly from each of the requested neighboring AP MLDs/APs over-the-Distribution System (DS) or backhaul; ii) fetch neighbor information for requested neighboring AP MLDs/APs from a controller/WLC; or iii) use a recent cached information for requested neighboring AP MLDs/APs. The serving AP MLD may return a Neighbor Probe Response frame that provides information in one or more Basic ML element(s) for neighboring AP MLDs/APs.

The Basic ML element provides neighbor AP MLD MAC address and includes one of more Per-STA Profile subelements that provide information for affiliated APs of the AP MLD based on the corresponding Neighbor Probe Request (i.e., may return information for a subset of affiliated APs and may return complete profile or partial profile (subset of elements) for each of the affiliated APs). Multiple Neighbor Probe Response frames may also be returned, one for each neighbor AP MLD/AP, each providing one Basic Multi-Link (ML) element. In one embodiment, each Neighbor Probe Response frame may provide information for multiple neighboring APs in multiple Basic Multi-Link element and serving AP MLD may still respond with multiple Neighbor Probe Response frames in response to a single Neighbor Probe Request frame, to provide faster responses to the client. For example, the serving AP MLD may send a Neighbor Probe Response frame as soon as it has neighbor information available for one or more requested neighboring AP MLDs/APs, without waiting to retrieve neighbor information for all requested neighboring AP MLDs/APs in the corresponding request frame. In this case, the serving AP MLD may send multiple Neighbor Probe Response frames.

### Neighbour Probe Request

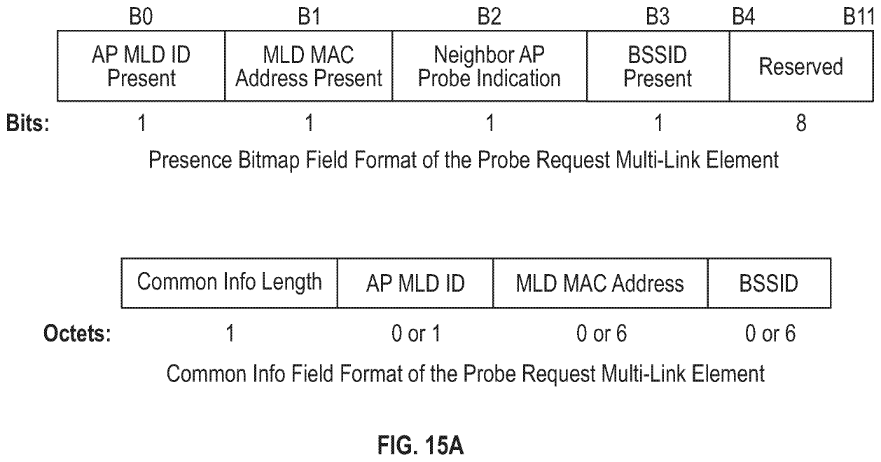

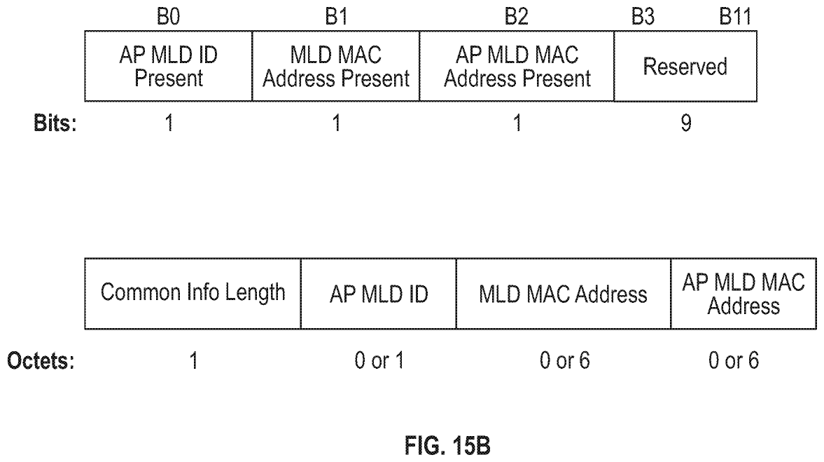

A Neighbor Probe Request frame may include one or more neighbour Probe Request ML elements(s) as described above. Address 1 and Address 3 in the frame may be set to BSSID of an affiliated AP of serving AP MLD. FIG. 15A illustrates an extended Probe Request ML element that can be carried in the Neighbor Probe Request frame. The neighbour Probe Request ML element may indicate in Presence Bitmap a ‘Neighbor AP Probe Indication’ to signal probing for neighbor AP MLD/AP. The Neighbor Probe Request frame may apply inheritance across STA profiles within and across different neighbour Probe Request ML elements included in the frame. The Request element or the Extended Request element included in first STA Profile may also apply to other STA Profiles in the request frame. A Non-Inheritance element may be included in the STA Profile, when inheritance should not apply for the STA Profile, by listing a set of elements that should not be inherited for that STA Profile from another STA profile (or the first STA Profile). Optionally, a neighbour Probe Request ML element may be used for requesting neighbor information for non-MLD APs as well. Special values for AP MLD ID (255) and Link ID (15) may be used as defined in IEEE 802.11be in this case. A BSSID may be included in the Common information field of the neighbour Probe Request ML element (per BSSID Present bit). A Per-STA Profile with Link ID=15 may be included to provide Request element and/or Extended Request element to request for specific elements. If SMD only includes AP MLDs, then this enhancement may not be needed, since the neighboring APs are always AP

MLDs. Neighbour Probe Response

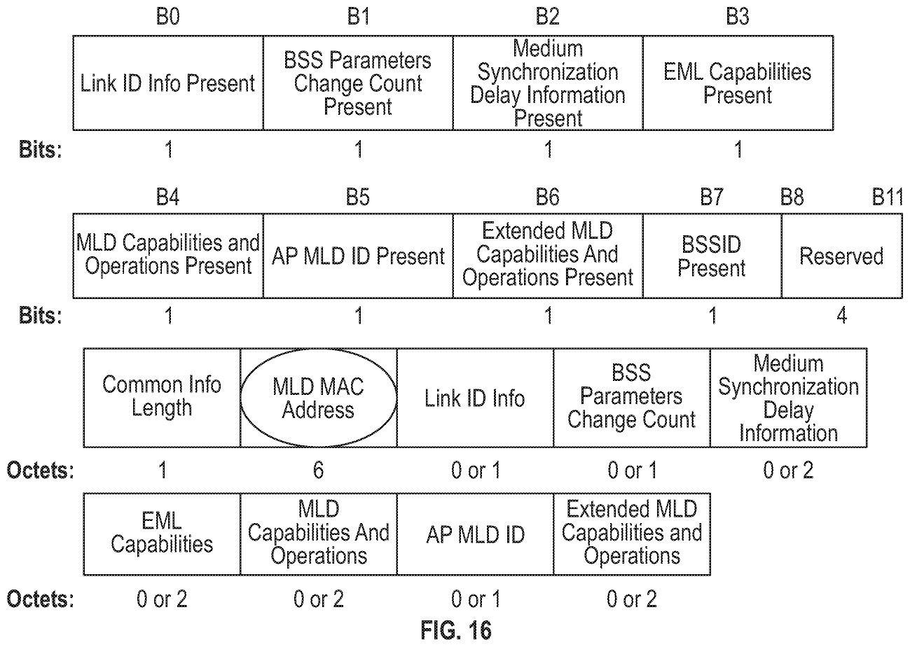

The Neighbor Probe Response frame may include one or more Basic ML elements proving information for one or more neighbour AP MLDs/APs. FIG. 16 illustrates an extended Basic ML element provided in the Neighbor Probe Response frame. A Presence bitmap in Basic ML element may be enhanced to indicate ‘Neighbour AP Information’. An MLD MAC Address field in the Common Info field of the Basic ML element is set to the neighbour AP MLD MAC Address for which probe response content is being provided in the Basic ML element. Alternatively, a new Neighbour AP MLD MLD MAC address field may be included in the Basic ML element (e.g., in the Common Info field). Per-STA Profiles in the Basic ML element may provide affiliated APs information of neighbour AP MLD. The Neighbor Probe Response frame may apply inheritance across STA profiles within and across different Basic ML elements. Elements included in first STA Profile of first Per-STA Profile of Basic ML element may also apply to other STA Profiles as well in the response frame. A Non-Inheritance element may be included in a STA Profile to indicate when inheritance should not apply for the STA Profile, by listing a set of elements that should not be inherited for that STA Profile from another STA profile (or the first STA Profile). Optionally a Basic ML element may be used to report neighbour information for non-MLD APs as well. If BSSID Present=1, MLD MAC Address may be set to BSSID of neighbour AP (or alternatively include a BSSID field in Common information). One Per-STA Profile with Link ID=15 may be included that provides neighbour AP info. If SMD only includes AP MLDs, this enhancement may not be needed. Once first client device 130 discovers the full or detailed probe response content information for the at least one of the plurality of APs in stage 930, method 900 may then end at stage 940.

### Enhancements to Pre-Association Discovery

A STA (i.e., client device) may perform active or passive scan to discover AP MLDs/APs within an SMD before performing association with the SMD. A STA may want to query some key set of information about neighboring AP MLDs/APs through one of the APs to assist in making a faster selection for desired AP MLD to associate with. A STA may send a broadcast or individually addressed Probe Request to one of the APs. In the Probe Request, the STA may request for an RNR element that provides information for neighboring APs. Embodiments of the disclosure may provide that the RNR provides information for both collocated and non-collocated neighboring APs (e.g., including affiliated APs of non-collocated neighboring AP MLDs).

If a client device desires to fetch some other information for neighboring APs (e.g. RSNE, BSS Load, etc.), then this may be requested by including an element that may specify a list of specific elements desired for the neighbors (e.g., using a Request element and/or an Extended Request elements, and may indicate a wildcard for neighbor identifiers (e.g., to signal interest in all relevant neighbors). In one embodiment, this element may be a neighbor Probe Request ML element that indicates a wildcard for neighbor discovery and may include Request element and/or Extended Request element. In another embodiments, this element may be a Neighbor Report element that may indicate a wildcard for BSSID and may include a Request element and/or Extended Request element in the Optional Subelements field. In yet another embodiment, this element may be a new element defined that may indicate a wildcard for neighbor discovery and may include a Request element and/or Extended Request element. The Probe Response sent by the AP may include the RNR and other elements (e.g., Neighbor Report elements or Basic ML elements or some new element), each of which may provide requested information for neighboring APs.

### Capability Signaling for Proposed Enhancements

Both the AP and the STA (i.e., client device) may signal support for enhanced capabilities described here (e.g., in UHR Capabilities element or in SMD Information element or in Extended Capabilities element or another element). These capabilities may include: i) BTM Enhancement for Neighbor Discovery Support; ii) Neighbor Probing through Serving AP Support; and iii) Pre-association Neighbor Discovery Support. With BTM Enhancement for Neighbor Discovery Support, a STA may send an enhanced BTM Query that includes either new Query reasons and/or Request element or Extended Request element only if the AP indicates support for this capability. An AP may send enhanced BTM Request (e.g., unsolicited BTM Request with a Reason Code information) only if STA indicates support for this capability. With Neighbor Probing through Serving AP Support, a STA should send Neighbor Probe Request only if AP indicates support for this capability. In this case, more granular capability may also be signaled indicating i) ‘Neighbor Probing Support within the SMD only’ which indicates that a client can request detailed probe response content from its serving AP MLD for neighboring APs in the same SMD; or ii) ‘Neighbor Probing Support within the ESS’ which indicates that a client can request detailed probe response content from its serving AP MLD for neighboring APs in the same ESS. With Pre-association Neighbor Discovery Support, this may be signaled only by the AP. An AP that does not support this capability would ignore new element(s) received in the Probe Request for requesting information for Neighbor APs.

### Neighbor Probe Request Format

The following describes a format for the aforementioned Neighbor Probe Request as illustrated by Table 1. The Neighbor Probe Request frame may be defined as a protected UHR action frame which is sent as PMF protected frame (i.e. encrypted). It may be called a UHR Neighbor Probe Request frame that is used by a UHR non-AP MLD for requesting probe response content of one or more neighboring/target AP MLDs. The Neighbor Probe Request frame may include zero or more (extended) Probe Request Multi-Link element, each indicating one neighboring AP MLD for which probe response information (i.e., detailed or full information as describe above) is requested. In one case, one or more Probe Request Multi-Link elements may be included. If no Probe Request Multi-Link element is included, then the current AP MLD may choose the most relevant neighbor AP MLDs (one or more) and may provide probe response information for those.

TABLE 1

| Order | Meaning |
|---|---|
| 1 | Category |
| 2 | Protected UHR Action |
| 3 | Dialog Token |
| 4 | Zero or more Probe Request ML element |

In one case, a Query Reason/Type field may be included requesting for specific type of neighbors (not shown above in Table 1). The ‘Transition and Transition Query reasons’ field from baseline may be used for this. New query reasons may be defined: i) ‘Query for Neighbor Information for SMD BSS transition’ (return information only for SMD neighbors); and ii) ‘Query for Neighbor Information for BSS Transition’ (return information for both SMD and non-SMD neighbors).

In the Probe Request ML element included in the Neighbor Probe Request frame, the fields may be interpreted as below:
i) Either an AP MLD ID or an MLD MAC Address field may be included to provide identifier for a neighboring AP MLD, based on what is known at the non-AP MLD; The AP MLD ID may provide a short identifier for a neighboring AP MLD for which probe response information is requested, and this may be obtained from the RNR element received in Probe Response from current AP MLD; The MLD MAC Address may provide the AP MLD MAC Address for a neighboring AP MLD for which probe response info is requested. This may be obtained from the NR elements received for neighbors from the current AP MLD (e.g., in BTM Request, Neighbor Report Response); and
ii) Alternatively, a ‘AP MLD MAC Address’ field may be added in the Common Info field of the Probe Request ML element as shown in FIG. 15B. This may be preferred since current MLD MAC Address field is used to provide identifier for the non-AP MLD in IEEE 802.11beThe presence of this new field is indicated by adding a new ‘AP MLD MAC Address Present’ bit in the Presence Bitmap field of the Probe Request ML element as shown in FIG. 17. The new field may be called ‘Neighbor AP MLD MAC Address’ or ‘Target AP MLD MAC Address’ and then present bit is named accordingly. In this case no AP MLD ID field is included in the Probe Request ML element.

In the Neighbor Probe Request frame, the baseline behavior as defined in IEEE 802.11be of requesting information for one or more affiliated APs of the AP MLD is extended to also apply in this case. This may mean that the Probe Request ML element may include one or more Per-STA Profile subelements to indicate set of affiliated APs for which probe response content is requested.

Additionally, the baseline behavior as defined in IEEE 802.11be of requesting complete profile or partial profile (using Request element and/or Extended Request element) information for each affiliated AP/link of the requested AP MLD is extended to also apply in this case. This may mean that the Probe Request ML element may include Request element and/or Extended Request element in the STA Profile field of a Per-STA profile subelement) to request for partial profile information for affiliated APs of the request AP MLD. In this case, the Complete Profile Requested field is set to 0 in the STA Control field. In one embodiment, the Request element and/or Extended Request element may only be included in the STA Profile of the first Per-STA Profile subelement (or included in only one of the STA Profile for any of the included Per-STA profile) and applied to all the affiliated APs for which partial profile is requested. In this case the same partial profile is requested for all the requested affiliated APs of the AP MLD and the Complete Profile Requested field is set to 0 for all the affiliated APs for which partial profile is requested but may not provide the Request element and/or Extended Request element in the STA Profile, and then these elements are taken and applied from another STA Profile (e.g. from the STA Profile in the first Per-STA profile).

In one embodiment, for some affiliated APs, Request element and/or Extended Request element may be included in some STA Profiles to specify set of elements requested for the partial profile for those affiliated APs and for other affiliated APs same partial profile is requested based and the Request element and/or Extended Request element included in the first per-STA profile is applied. In one embodiment, a Probe Request Multi-Link element may request complete profile for some affiliated APs of a neighboring AP MLD (by setting the Complete Profile Requested field to 1) and may request partial profile for some other affiliated APs of that neighboring AP MLD (by setting the Complete Profile Requested field to 0).

In one case, the Neighbor Probe Request frame may also be used to request a complete profile (or the partial profile) for the affiliated APs of the current AP MLD using PMF protected frame exchange (instead of unprotected probe request/response exchange). For example, it may be used after BSS parameters critical update and if the non-AP MLD could not acquire updated parameters from the beacon. In that case, a flag/field may be added in Probe Request ML element (e.g., in Presence Bitmap) indicating ‘Requesting Probe Response content of Current AP MLD’. The AP MLD ID or AP MLD MAC Address for current AP MLD may be optionally included. In one case, when requesting information for current AP MLD using the Neighbor Probe Request, the AP MLD ID or AP MLD MAC Address field is set to indicate the current AP MLD, and no sperate flag is needed. Baseline behavior of requesting information for one or more affiliated APs of the AP MLD and requesting complete profile or partial profile for those affiliated AP/links of the current AP MLD also applies.

### Neighbor Probe Response Format

The following describes a format for the aforementioned Neighbor Probe Response as illustrated by Table 2. The Neighbor Probe Response may comprise a protected UHR action frame which is sent as PMF protected frame (i.e. encrypted). It may be called a UHR Neighbor Probe Response frame that is sent by a UHR AP MLD for providing probe response content of one or more neighboring/target AP MLDs. The Dialog Token field in the Neighbor Probe Response is set to the same value as the Dialog Token value received in the corresponding Neighbor Probe Request. The Neighbor Probe Response may include an overall Status Code that may indicate the outcome of the neighbor probe request. In one case, Statis Code may not be included. Optionally, a list of <Target AP MLD MAC Address, Status Code> tuples may be returned in the response (in addition or instead of overall Status Code), indicating status per requested target AP MLD.

TABLE 2

| Order | Meaning |
|---|---|
| 1 | Category |
| 2 | Protected UHR Action |
| 3 | Dialog Token |
| 4 | Status Code |
| 5 | Zero or more Basic ML element |

One or more Basic Multi-Link element may be included in the Neighbor Probe Response to provide probe response content for one or more neighboring/target AP MLDs, if probe response content could be provided for at least one neighboring/target AP MLD. One Basic ML element may be included for each neighboring AP MLD for which probe response information is provided. Per baseline behavior defined in IEEE 802.11be, one Per-STA Profile may be included for each affiliated AP/link for which probe response content was requested or is provided. In each Per-STA Profile, complete profile or partial profile information may be provided based on what was requested in the request frame (or based on AP side policy). When no neighbor information could be provided in the Neighbor Probe Response, then no Basic ML element may be included.

The overall Status Code may indicate the outcome of neighbor probe request. It may be set to possible status codes below (or variation of these names), indicating specific outcomes:
i) SUCCESS;
ii) SUCCESS_PARTIAL_LIST (current AP is returning information for partial list of neighboring AP MLDs, e.g. in cases when some requested neighbors are not known or too many neighbors requested or when information for some neighbors could not be retrieved or is not available);
iii) SUCCESS_MORE_TO_FOLLOW (current AP is returning information for partial list of neighboring AP MLDs and will provide information for more neighboring AP MLDs in a follow up neighbor probe response frame);
iv) REJECTED_UNKNOWN_NEIGHBOR (all requested neighboring AP MLDs are not known);
v) REJECTED_NEIGHBOR_INFO_UNAVAILABLE (information for all requested neighboring AP MLDs is not available);
vi) REJECTED_TEMPORAILY_TRY_AGAIN (e.g. if neighbor info could not be retrieved from neighboring APs or WLC due to some network issue, client should try again); and
vii) REJECTED_TOO_MANY_NEIGHBORS_REQUESTED (request is rejected because it asked for probe response information for too many neighboring AP MLD which may exceed policy from the AP).

Other existing status codes may be used in the response too, e.g.:
i) REQUEST_DECLINED;
ii) REFUSED_TEMPORARILY (e.g. if neighbor information could not be retrieved, client should try again);
iii) INVALID_PARAMETERS; and
v) STATUS_INVALID_ELEMENT.

In one embodiment, the AP may advertise a policy which indicates the maximum number of neighboring AP MLDs for which probe response information can be requested using Neighbor Probe Request frame. Then, a client may only request probe response information for up to this maximum limit in the Neighbor Probe Request frame.

### Capability Indication for Neighbor Probe Request/Response

In some embodiments, the capability for supporting neighbor AP/AP MLD probing through current/serving AP MLD is signaled by the AP MLD in Beacon, Probe Response, (Re) Association Response frames etc. In one case, the capability field(s)/bits is added in the SMD Information element to indicate whether requesting probe response content for neighboring AP MLDs via the serving AP MLD is supported. In another case, the capability field(s)/bits is added to the UHR Capabilities element. At least one of the following capabilities may be defined:
i) Neighbor Probing Support within SMD: This indicates whether the AP MLD supports a non-AP MLD requesting probe response content for neighboring AP MLDs within the SMD. Set to 1 if supported, else set to 0. Set to same value for all AP MLDs in the SMD.
ii) Neighbor Probing Support within ESS: Whether the AP MLD supports a non-AP MLD requesting probe response content for neighboring AP MLDs within the ESS (not just the SMD). Set to 1 if supported, else set to 0. Set to same value for all AP MLDs in the SMD. Can be set to same or different values by AP MLDs in the ESS based on their supported capability.
   In one embodiment, an AP MLD may support both of the above capability and indicates that by setting both the capability bits to 1. In one embodiment, one single capability field can be defined which indicates either capability support as below (or different values assignment):
i. 0: Neighbor Probing not supported.
ii. 1: Neighbor Probing Supported only within SMD
iii. 2: Neighbor Probing Supported within ESS

In some embodiments, Instead of defining new set of UHR Neighbor Probe Request and Response frames, following alternate embodiments may be defined:
i) Use UHR Link Reconfiguration Notify frame for Neighbor probing: In one embodiment, the UHR Link Reconfiguration Notify frame is used by the non-AP MLD to request probe response content for neighboring AP MLDs (one or more). A new Type value is used for the UHR Link Reconfiguration Notify frame indicating ‘Neighbor Probing’ or ‘Fetch Probe content’ or similar. For this new Type value the UHR Link Reconfiguration Notify frame includes one or more Probe Request Multi-Link element that follows all the rules as described above for Neighbor Probe Request frame. The response from the AP MLD that provides probe response content for neighboring/target AP MLDs is another UHR Link Reconfiguration Notify frame (with the same Dialog Token value as received in the corresponding UHR Link Reconfiguration Notify frame received from the client) and which uses the same new Type value, and includes the following fields:
   Status Code (optional)
   Zero or more Basic ML element (or Reconfiguration ML element) providing probe response content for the AP MLD as part of Per-STA Profile subelements.
   The Dialog Token field.
ii) Use UHR Link Reconfiguration Request/Response frames for Neighbor probing: In one embodiment, the UHR Link Reconfiguration Request frame can be used to request probe response content for neighboring/target AP MLDs. As in option i) above, a new Type value is defined and used for this purpose. The UHR Link Reconfiguration Request frame includes one or more Probe Request Multi-Link element (or Reconfiguration ML element) for this new Type value (and does not include other elements which are not applicable). AP sends a UHR Link Reconfiguration Response frame with the same new Type value to provide probe response content for neighboring/target AP MLDs, which includes
   Status Code (optional)
   Zero or more Basic ML element (or Reconfiguration ML element) providing probe response content for the AP MLD as part of Per-STA Profile subelements.
      The Dialog Token field in the UHR Link Reconfiguration Response (with the new Type value) is set to the same value as the Dialog Token value received in the corresponding UHR Link Reconfiguration Request frame (with the new Type value).

FIG. 17 shows computing device 1700. As shown in FIG. 17, computing device 1700 may include a processing unit 1710 and a memory unit 1715. Memory unit 1715 may include a software module 1720 and a database 1725. While executing on processing unit 1710, software module 1720 may perform, for example, processes for providing discovery enhancements for improved roaming as described above with respect to FIG. 2. Computing device 1700, for example, may provide an operating environment for controller 105, first AP 115, second AP 120, third AP 125, first client device 130, second client device 135, or third client device 140. Controller 105, first AP 115, second AP 120, third AP 125, first client device 130, second client device 135, or third client device 140 may operate in other environments and are not limited to computing device 1700.

Computing device 1700 may be implemented using a Wi-Fi access point, a tablet device, a mobile device, a smart phone, a telephone, a remote control device, a set-top box, a digital video recorder, a cable modem, a personal computer, a network computer, a mainframe, a router, a switch, a server cluster, a smart TV-like device, a network storage device, a network relay device, or other similar microcomputer-based device. Computing device 1700 may comprise any computer operating environment, such as hand-held devices, multiprocessor systems, microprocessor-based or programmable sender electronic devices, minicomputers, mainframe computers, and the like. Computing device 1700 may also be practiced in distributed computing environments where tasks are performed by remote processing devices. The aforementioned systems and devices are examples, and computing device 1700 may comprise other systems or devices.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the disclosure.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to, mechanical, optical, fluidic, and quantum technologies. In addition, embodiments of the disclosure may be practiced within a general purpose computer or in any other circuits or systems.

Embodiments of the disclosure may be practiced via a system-on-a-chip (SOC) where each or many of the element illustrated in FIG. 1 may be integrated onto a single integrated circuit. Such an SOC device may include one or more processing units, graphics units, communications units, system virtualization units and various application functionality all of which may be integrated (or “burned”) onto the chip substrate as a single integrated circuit. When operating via an SOC, the functionality described herein with respect to embodiments of the disclosure, may be performed via application-specific logic integrated with other components of computing device 1700 on the single integrated circuit (chip).

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for embodiments of the disclosure.

What is claimed is:

1. A method comprising
establishing, by an access point (AP) multilink device (MLD), an association between a Seamless Mobility Domain (SMD) and a non-AP MLD,
wherein the SMD comprises the AP MLD and a second AP MLD,
wherein the association comprises at least one link between a first affiliated AP of the AP MLD and a first STA of the non-AP MLD;
sending, by the AP MLD, one or more wireless frames including information indicating a first set of profile information of one or more APs of the second AP MLD;
receiving, by the AP MLD, a neighbor probe request frame from the non-AP MLD,
the neighbor probe request frame indicating the second AP MLD;
accessing, by the AP MLD, profile information for the second AP MLD to generate a neighbor probe response frame; and
sending, by the AP MLD, the neighbor probe response frame to the non-AP MLD,
the neighbor probe response frame including a second set of profile information for the one or more APs of the second AP MLD, wherein the second set of profile information includes additional profile information relative to the first set of profile information.

2. The method of claim 1 wherein the first set of profile information is a subset of a complete profile and wherein the second set of profile information is a complete profile.

3. The method of claim 1 wherein the neighbor probe request frame indicates one or more requested APs of the second AP MLD, and wherein the neighbor probe response frame includes the second set of profile information for each AP of the one or more requested APs of the second AP MLD.

4. The method of claim 3 wherein the neighbor probe request frame comprises a basic multi-link element including one or more per-STA profile subelements corresponding to each requested AP.

5. The method of claim 1 wherein accessing profile information for the second AP MLD comprises probing, by the AP MLD, the second AP MLD for the profile information.

6. The method of claim 1 wherein accessing profile information for the second AP MLD comprises fetching, by the AP MLD, the profile information from a controller.

7. The method of claim 1 wherein accessing profile information for the second AP MLD comprises retrieving, by the AP MLD, the profile information from a cache.

8. The method of claim 1 further comprising receiving, by the AP MLD, a Basic Service Set (BSS) Transition Management (BTM) query frame from the non-AP MLD, the BTM query frame including a reason code, the reason code corresponding to SMD roaming; and
responsive to the BTM query frame and the reason code, transmitting a BTM request frame, the BTM request frame including information for one or more neighboring AP MLDs,
the neighboring AP MLDs including at least the second AP MLD,
the BTM request frame including one or more Neighbor Report (NR) elements,
each NR element corresponding to an AP of a neighboring AP MLD and including information indicating a subset of a complete profile of the corresponding AP.

9. The method of claim 8 wherein the subset comprises one or more of a BSS Load element, a UHF Operation element, a UHR Capabilities element, or a Basic Multi-Link element.

10. The method of claim 9 wherein, for a third AP MLD of the one or more neighboring AP MLDs not in the same SMD, the subset further comprises one or more of a security information element, a RSNE element or a RSNXE element.

11. An access point (AP) multi-link device (MLD) comprising:
one or more affiliated APs;
at least one memory element for storing data; and
at least one processor for executing instructions associated with the data, wherein executing the instructions causes the AP MLD to perform operations, comprising
establishing an association between a Seamless Mobility Domain (SMD) and a non-AP MLD, wherein the SMD comprises the AP MLD and a second AP MLD,
wherein the association comprises at least one link between a first affiliated AP of the AP MLD and a first STA of the non-AP MLD;
sending one or more wireless frames including information indicating a first set of a profile information of one or more APs of the second AP MLD;
receiving a neighbor probe request frame from the non-AP MLD, the neighbor probe request frame indicating the second AP MLD;
accessing profile information for the second AP MLD to generate a neighbor probe response frame; and
sending the neighbor probe response frame to the non-AP MLD, the neighbor probe response frame including a second set of profile information for the one or more APs of the second AP MLD, wherein the second set of profile information includes additional profile information relative to the first set of profile information.

12. The AP MLD of claim 11 wherein the first set of profile information is a subset of a complete profile and wherein the second set of profile information is a complete profile.

13. The AP MLD of claim 11 wherein the neighbor probe request frame indicates one or more requested APs of the second AP MLD, and wherein the neighbor probe response frame includes the second set of profile information for each AP of the one or more requested APs of the second AP MLD.

14. The AP MLD of claim 13 wherein the neighbor probe request frame comprises a basic multi-link element including one or more per-STA profile subelements corresponding to each requested AP.

15. The AP MLD of claim 11 wherein accessing profile information for the second AP MLD comprises probing, by the AP MLD, the second AP MLD for the profile information.

16. The AP MLD of claim 11 wherein accessing profile information for the second AP MLD comprises fetching, by the AP MLD, the profile information from a controller.

17. The AP MLD of claim 11 wherein accessing profile information for the second AP MLD comprises retrieving, by the AP MLD, the profile information from a cache.

18. The AP MLD of claim 11, the operations further comprising
receiving, by the AP MLD, a Basic Service Set (BSS) Transition Management (BTM) query frame from the non-AP MLD, the BTM query frame including a reason code, the reason code corresponding to SMD roaming; and
responsive to the BTM query frame and the reason code, transmitting a BTM request frame, the BTM request frame including information for one or more neighboring AP MLDs,
the neighboring AP MLDs including at least the second AP MLD,
the BTM request frame including one or more Neighbor Report (NR) elements,
each NR element corresponding to an AP of a neighboring AP MLD and including information indicating a subset of a complete profile of the corresponding AP.

19. The AP MLD of claim 18 wherein the subset comprises one or more of a BSS Load element, a UHF Operation element, a UHR Capabilities element, or a Basic Multi-Link element.

20. The AP MLD of claim 19 wherein, for a third AP MLD of the one or more neighboring AP MLDs not in the same SMD, the subset further comprises one or more of a security information element, a RSNE element or a RSNXE element.

21. A non-transitory computer readable storage medium comprising instructions that when executed configure one or more processors of an access point (AP) multi-link device (MLD) to perform operations comprising:
establishing an association between a Seamless Mobility Domain (SMD) and a non-AP MLD, wherein the SMD comprises the AP MLD and a second AP MLD,
wherein the association comprises at least one link between a first affiliated AP of the AP MLD and a first STA of the non-AP MLD;
sending one or more wireless frames including information indicating a first set of a profile information of one or more APs of the second AP MLD;
receiving a neighbor probe request frame from the non-AP MLD, the neighbor probe request frame indicating the second AP MLD;
accessing profile information for the second AP MLD to generate a neighbor probe response frame; and
sending the neighbor probe response frame to the non-AP MLD, the neighbor probe response frame including a second set of profile information for the one or more APs of the second AP MLD, wherein the second set of profile information includes additional profile information relative to the first set of profile information.

22. The non-transitory computer readable storage medium of claim 21 wherein the first set of profile information is a subset of a complete profile and wherein the second set of profile information is a complete profile.

23. The non-transitory computer readable storage medium of claim 21 wherein the neighbor probe request frame indicates one or more requested APs of the second AP MLD, and wherein the neighbor probe response frame includes the second set of profile information for each AP of the one or more requested APs of the second AP MLD.

24. The non-transitory computer readable storage medium of claim 23 wherein the neighbor probe request frame comprises a basic multi-link element including one or more per-STA profile subelements corresponding to each requested AP.

25. The non-transitory computer readable storage medium of claim 21 wherein accessing profile information for the second AP MLD comprises probing, by the AP MLD, the second AP MLD for the profile information.

26. The non-transitory computer readable storage medium of claim 21 wherein accessing profile information for the second AP MLD comprises fetching, by the AP MLD, the profile information from a controller.

27. The non-transitory computer readable storage medium of claim 21 wherein accessing profile information for the second AP MLD comprises retrieving, by the AP MLD, the profile information from a cache.

28. The non-transitory computer readable storage medium of claim 21, the operations further comprising
receiving, by the AP MLD, a Basic Service Set (BSS) Transition Management (BTM) query frame from the non-AP MLD, the BTM query frame including a reason code, the reason code corresponding to SMD roaming; and
responsive to the BTM query frame and the reason code, transmitting a BTM request frame, the BTM request frame including information for one or more neighboring AP MLDs,
the neighboring AP MLDs including at least the second AP MLD,
the BTM request frame including one or more Neighbor Report (NR) elements,
each NR element corresponding to an AP of a neighboring AP MLD and including information indicating a subset of a complete profile of the corresponding AP.

29. The non-transitory computer readable storage medium of claim 28 wherein the subset comprises one or more of a BSS Load element, a UHF Operation element, a UHR Capabilities element, or a Basic Multi-Link element.

30. The non-transitory computer readable storage medium of claim 29 wherein, for a third AP MLD of the one or more neighboring AP MLDs not in the same SMD, the subset further comprises one or more of a security information element, a RSNE element or a RSNXE element.
